(19) United States
(12) Patent Application Publication
(10) Pub. No.: US 2017/0117797 A1
(43) Pub. Date: Apr. 27, 2017

(54) MODULE FOR A CONVERTER AND METHOD FOR CONTROLLING FAULT CURRENTS IN A CONVERTER

(71) Applicant: SIEMENS AKTIENGESELLSCHAFT, Muenchen (DE)

(72) Inventors: JOERG DORN, BUTTENHEIM (DE); DOMINIK ERGIN, BAIERSDORF (DE); HERBERT GAMBACH, UTTENREUTH (DE); KLEMENS KAHLEN, NUERNBERG (DE); MARTIN PIESCHEL, NUERNBERG (DE); GUENTER SACHS, HERZOGENAURACH (DE); DANIEL SCHMITT, NUERNBERG (DE); ANDREAS ZENKNER, OBERMICHELBACH (DE)

(21) Appl. No.: 15/299,839

(22) Filed: Oct. 21, 2016

(30) Foreign Application Priority Data
Oct. 21, 2015 (DE) 102015220527.4

(51) Int. Cl. H02M 1/32

(52) U.S. Cl. CPC H02M 1/32

(57) ABSTRACT

A module for a converter includes submodules, a first coupling inductor and a second coupling inductor which is activatable in the event of a fault. A method for controlling fault currents in a converter is also provided.

### CROSS-REFERENCE TO RELATED APPLICATION

This application claims the priority, under 35 U.S.C. §119, of German Patent Application DE 10 2015 220 527.4, filed Oct. 21, 2015; the prior application is herewith incorporated by reference in its entirety.

### BACKGROUND OF THE INVENTION

### Field of the Invention

The invention relates to a module for a converter including submodules and a coupling inductor. The invention also relates to a method for controlling fault currents in a converter having modules, submodules and a coupling inductor.

High-voltage direct-current (HVDC) transmission systems are increasingly used in order, for example, to connect offshore wind farms to the mainland, because such systems cause comparatively few energy losses in the energy transmission and produce a stabilizing effect for a connected power network, e.g. through a reactive power correction. A part of the transmission losses is caused by converters which convert the direct-current voltage into alternating-current voltage (and vice versa). Modular multi-level converters (M2C) are particularly suitable, in which semiconductor switches are controlled in a multiplicity of modules with capacitors in such a way that a suitable output voltage is generated.

Modular multi-level converters are used not only in HVDC systems but, for example, also in flexible AC transmission systems (FACTS), particularly in “Static Synchronous Compensator (STATCOM)” systems, with which reactive power can be fed from the STATCOM into the network. The three phases are interconnected in a delta connection for that purpose.

A modular multi-level converter with a multiplicity of modules is known from European Patent EP 1497911 B1, corresponding to U.S. Pat. No. 7,269,037.

In existing modules, a single coupling inductor is used which is normally constructed as a choke coil. The coupling inductor must be dimensioned to be so large that, particularly in the event of a fault, i.e., for example, in the case of a short-circuit current, high currents are avoided in the module so that no damage occurs. Since a voltage drops on the coupling inductor, the submodules used in the module must expend a part of the voltage provided by them in order to run a current through the coupling inductor. In particular, the converter voltage depends strongly on the size of the inductor that is used.

### SUMMARY OF THE INVENTION

It is accordingly an object of the invention to provide a module for a converter, which overcomes the hereinafore-mentioned disadvantages of the heretofore-known modules of this general type and with which the operation of the converter can be adapted dynamically to the respective operating situation.

With the foregoing and other objects in view there is provided, in accordance with the invention, a module for a converter. The module comprises submodules, a first coupling inductor, and a second coupling inductor being activatable in an event of a fault.

Through the use of the second coupling inductor, the first coupling inductor which is constructed to be smaller than was previously customary can be used in the normal operation of the converter, i.e. when no fault or short circuit is present. It is only in the event of a fault that the second coupling inductor is activated in order to control the fault current. It is an important advantage of the invention that a smaller number of submodules is required in normal operation in order to run a current through the first coupling inductor.

According to the invention, a module is understood to mean a configuration with submodules which in each case have semiconductor switches which, with corresponding control by using a control device, can provide an AC voltage in total as an output voltage. A module is normally disposed in a branch of a converter or a static reactive power divider of the type used for reactive power compensation. The first and second coupling inductors are regarded as parts of the configuration, so that even a module constructed as a separate component and the two coupling inductors together form a module according to the invention.

If, for example, a predefined limit current is exceeded, the second coupling inductor can be activated within 1 ms in order to control the fault current.

If the heretofore used coupling inductor is divided, for example, in such a way that ⅔ are allocated to the first coupling inductor and ⅓ to the second coupling inductor, approximately 5-10% of the modules can be saved. The second coupling inductor could, for example, have 50 mH.

Since each submodule generates operating losses, e.g. through energy losses in the switching of the semiconductor switches in a module, the energy losses are reduced accordingly in the converter. This enables substantial cost savings.

The module may be used, for example, in a modular multi-level converter or in a phase module of a “Static Voltage Converter” (SVC). If a three-phase network is used, three modules are normally used which are provided in each case with the second coupling inductor according to the invention.

In a preferred embodiment of the module according to the invention, the second coupling inductor is connected in parallel to a switching device. This is an advantage because the second coupling inductor can thus be particularly simply activated or deactivated.

In a further preferred embodiment of the module according to the invention, the switching device is constructed to be opened in the event of a fault. This is an advantage because the switching device can be kept closed in normal operation so that the second coupling inductor is bypassed. It is only in the event of a fault that the switching device is opened in order to force the current flow through the second coupling inductor.

In a further preferred embodiment of the module according to the invention, the switching device has two antiparallel-connected semiconductor switches. This is an advantage because switching can be effected particularly quickly by using the semiconductor switches in the event of a fault by opening the semiconductor switches. The semiconductor switches can be controlled e.g. by a module control device which also defines the switching sequences for semiconductor switches in the submodules. Since the semiconductor switches are closed in normal operation, they generate energy losses depending on the construction, but these are significantly smaller than the energy losses saved by the smaller construction of the first coupling inductor. The semiconductor switches may be constructed e.g. as IGBTs.

In a further preferred embodiment of the module according to the invention, the switching device has a mechanical switch. This is an advantage because a mechanical switch enables a safe deactivation of the fault current.

In a further preferred embodiment of the module according to the invention, the switching device has a surge arrester. This is an advantage because the surge arrester prevents a disruptive discharge of the switching device.

In a further preferred embodiment of the module according to the invention, the switching device is constructed to be closed in the event of a fault. This is an advantage because in this way the switching device is opened in normal operation, thereby reducing the forward losses by the switching device.

In a further preferred embodiment of the module according to the invention, the second coupling inductor is allocated to a submodule. This is an advantage because in this way the coupling inductor can be combined with a submodule e.g. in a compact construction.

In a further preferred embodiment of the module according to the invention, at least one additional coupling inductor is provided. This is an advantage because the total coupling inductance activated in the module can thus be increased gradually in order to control e.g. transient faults of different magnitudes. It is particularly preferred if each or a predefined number of selected submodules is provided in each case with an integrated coupling inductor, since a particularly good scalability is thus achieved.

In a further preferred embodiment of the module according to the invention, the submodules have semiconductor switches which are controllable in the event of a fault differently from in normal operation and in each case depending on the total coupling inductance activated in the module.

In a further preferred embodiment of the module according to the invention, the first and second coupling inductors are constructed as magnetically coupled partial windings. The two magnetically coupled partial windings can be wound in opposition. Similar constructions for coils are known, for example, for on-board power supply systems of ships from the http://www.schild.net/duplexdrossel/1/website, wherein duplex chokes serve there, in particular, to increase short-circuit protection. The duplex chokes form separate longitudinal reactances in each case for two outputs which limit the short-circuit currents.

It is an advantage of this embodiment that only small transient over voltages occur in the activation of the second coupling inductor. This construction is furthermore quickly and simply controllable and is mechanically and electrically insensitive.

In a further preferred embodiment of the module according to the invention, the first and second coupling inductors are constructed as magnetically coupled partial windings. This is an advantage because this construction is particularly space-saving. Duplex chokes are known which are constructed as transformers by using magnetic coupling through a core material. Conversely, the second coupling inductor can also be constructed as an air choke with center tapping, thus enabling lower material costs with a comparable mode of operation.

In a further preferred embodiment of the module according to the invention, the partial winding corresponding to the second coupling inductor is activatable by using an actuator. This is an advantage because a control is thus possible.

In a further preferred embodiment of the module according to the invention, the actuator has two antiparallel-connected semiconductor switches. These semiconductor switches may, for example, for their part be formed of a series connection of semiconductor switches. The use of semiconductor switches is an advantage because a fast switching is enabled. Furthermore, semiconductor switches can substantially be operated in a maintenance-free manner and can also be opened in the energized condition.

In a further preferred embodiment of the module according to the invention, the actuator has a current source. This is an advantage because a continuous setting of the total inductance is possible, whereby lower electrical loads occur in operation.

In a further preferred embodiment of the module according to the invention, the actuator has a capacitor. This is an advantage because the capacitor can be tuned to the coupling inductances in such a way that the effective inductance is comparatively lower when the capacitor is activated.

Furthermore, it is an object of the invention to provide a method for controlling fault currents in a converter, which overcomes the hereinafore-mentioned disadvantages of the heretofore-known methods of this general type and with which the operation of the converter can be adapted dynamically to the respective operating situation.

With the objects of the invention in view, there is concomitantly provided a method for controlling fault currents in a converter including modules, submodules and a first coupling inductor. The method comprises detecting a fault event, and activating a second coupling inductor in an event of a fault. This accordingly offers the same advantages as explained initially for the module according to the invention.

Other features which are considered as characteristic for the invention are set forth in the appended claims.

Although the invention is illustrated and described herein as embodied in a module for a converter and a method for controlling fault currents in a converter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram of a modular multi-level converter;

FIG. 2 is a schematic diagram of a static reactive power controller;

FIG. 3 is a schematic diagram of a first example embodiment of a module according to the invention;

FIG. 4 is a schematic diagram of a detailed view of a second coupling inductor with a switching device;

FIG. 5 is a schematic diagram of a first example embodiment of a switching device;

FIG. 6 is a schematic diagram of a second example embodiment of a switching device; and

FIG. 7 is a schematic diagram of an example embodiment of first and second coupling inductors which are constructed as magnetically coupled partial windings of a single coil.

### DETAILED DESCRIPTION OF THE INVENTION

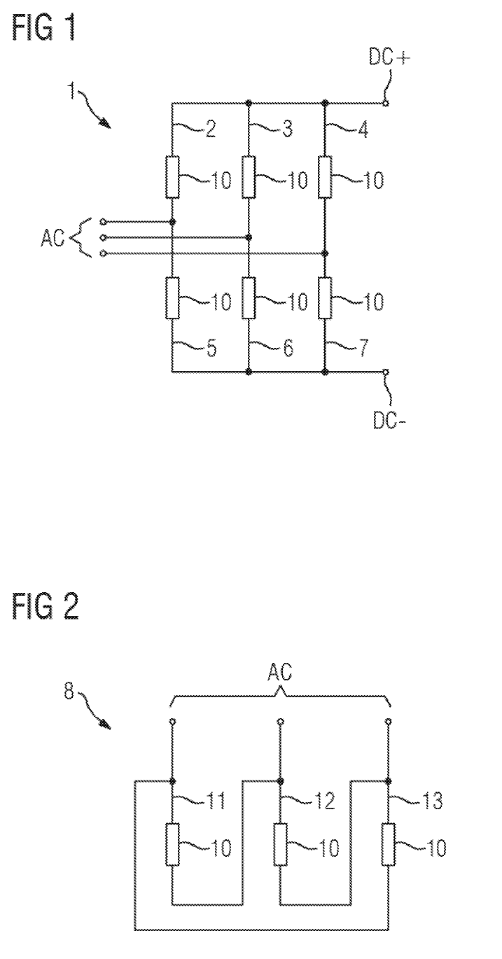

Referring now to the figures of the drawings in detail and first, particularly, to FIG. 1 thereof, there is seen a modular multi-level converter 1 which is connected on the AC voltage side to a three-phase network AC. Connections DC+ and DC− are present on the DC voltage side. A module 10 is used in each case for each converter branch 2-7.

FIG. 2 shows a static reactive power controller 8 which is used for reactive power compensation in the three-phase alternating-current voltage network AC. It has three branches 11-13, each with one module 10.

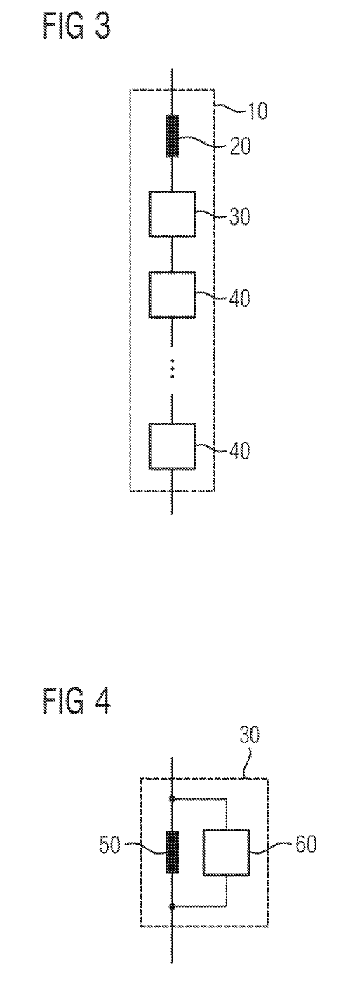

FIGS. 3 and 4 show a module 10 in a detailed view. A first coupling inductor 20, a device 30 for increasing the total inductance and submodules 40 are connected in series. The device 30 has a second coupling inductor 50 and a switching device 60.

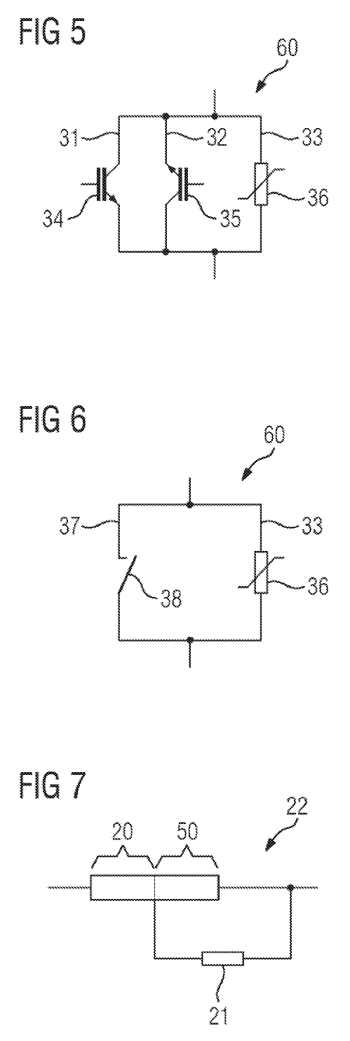

FIG. 5 shows a first example embodiment of a switching device 60 which has two antiparallel-connected semiconductor switches (e.g. IGBTs) 34, 35 in switching device branches 31 and 32. A surge arrester 36 is disposed in a switching device branch 33.

FIG. 6 shows a second example embodiment of a switching device 60 which has a mechanical switch 38 in a switching device branch 37. A surge arrester 36 is disposed in a switching device branch 33.

FIG. 7 shows an example embodiment of first and second coupling inductors 20, 50 which are constructed as magnetically coupled partial windings of a single coil 22. The partial windings are wound in opposition. The partial winding corresponding to the second coupling inductor can be activated or deactivated by using an actuator 21.

1. A module for a converter, the module comprising:
submodules;
a first coupling inductor; and
a second coupling inductor being connected in series with said submodules and said first coupling inductor, said second coupling inductor being activatable in an event of a fault.

2. The module according to claim 1, which further comprises a switching device connected in parallel to said second coupling inductor.

3. The module according to claim 2, wherein said switching device is constructed to be opened in an event of a fault.

4. The module according to claim 2, wherein said switching device includes two antiparallel-connected semiconductor switches.

5. The module according to claim 2, wherein said switching device includes a mechanical switch.

6. The module according to claim 2, wherein said switching device includes a surge arrester.

7. The module according to claim 2, wherein said switching device is constructed to be closed in an event of a fault.

8. The module according to claim 1, wherein said second coupling inductor is allocated to one of said submodules.

9. The module according to claim 1, which further comprises at least one additional coupling inductor.

10. The module according to claim 1, wherein said submodules have semiconductor switches being controllable in an event of a fault differently from in normal operation and each depending on a total coupling inductance activated in the module.

11. The module according to claim 1, wherein said first and second coupling inductors are constructed as magnetically coupled partial windings.

12. The module according to claim 11, wherein said partial winding corresponding to said second coupling inductor is activatable by an actuator.

13. The module according to claim 12, wherein said actuator has two antiparallel-connected semiconductor switches.

14. The module according to claim 12, wherein said actuator has a current source.

15. The module according to claim 12, wherein said actuator has a capacitor.

16. A method for controlling fault currents in a converter, the method comprising the following steps:
providing the converter with modules, submodules and a first coupling inductor;
detecting a fault event; and
activating a second coupling inductor in an event of a fault.
